(19) United States
(12) Patent Application Publication
(10) Pub. No.: US 2024/0370597 A1
(43) Pub. Date: Nov. 7, 2024

(54) METHOD FOR SOLVING PARAMETERS OF EXTENSION/COMPRESSION SPRING BY AC SALP SWARM ALGORITHM

(71) Applicant: Wenzhou University, Zhejiang (CN)

(72) Inventors: Pengjun WANG, Zhejiang (CN); Chao Lin, Zhejiang (CN); Gang LI, Zhejiang (CN)

(73) Assignee: Wenzhou University, Zhejiang (CN)

(21) Appl. No.: 18/689,427

(22) PCT Filed: Dec. 16, 2022
(86) PCT No.: PCT/CN2022/139474

§ 371 Date: Mar. 6, 2024

(30) Foreign Application Priority Data
Apr. 29, 2022 (CN) 202210491595.X

(51) Int. Cl. G06F 30/17

(52) U.S. Cl. CPC G06F 30/17

(57) ABSTRACT

Disclosed is a method for solving parameters of extension/compression springs by an AC salp swarm algorithm, including the following steps. Determine design parameters to be solved of an extension/compression spring. Construct an objective function for solving the design parameters of the extension/compression spring based on a design objective of the extension/compression spring, wherein the design objective of the extension/compression spring is to minimize the weight of the extension/compression spring. Determine constraints of the design parameters of the extension/compression spring. Perform iterative optimization on the design parameters of the extension/compression spring using an AC salp swarm algorithm to obtain a globally optimal solution, and output the globally optimal solution as solved design parameters of the extension/compression spring, wherein the AC salp swarm algorithm is obtained by adding an AC operation between individuals during an iteration process of an existing salp swarm algorithm.

### BACKGROUND OF THE INVENTION

### 1. Technical Field

The invention relates to a method for solving design parameters, in particular to a method for solving parameters of extension/compression springs by an AC salp swarm algorithm.

### 2. Description of Related Art

Structural optimization is an important field related to both optimization and structural engineering. The design of extension/compression springs, as a structural optimization, relates to many different design variables and highly nonlinear constraints, and it is very important to find optimal possible design parameters according to the design objective. The selection of the design parameters of extension/compression springs will exert an influence on the performance or objective of a related system to which the extension/compression springs are applied.

At present, methods for solving the design parameters of extension/compression springs mainly include the analytical method, the numerical calculation method and the optimization algorithm-based estimation method. The analytical method can solve the design parameters quickly, but it solves the design parameters through approximate processing, which greatly reduces the accuracy of a solution. The numerical calculation method obtains a solution mainly by randomly selecting an initial value and observing the astringency of the initial value, so the accuracy of the solution not only depends on the selection of the initial value, but also will decrease with the increase of design parameters. The optimization algorithm-based estimation method, as an iterative method with parameter adjustment, is a novel method for solving the design parameters of extension/compression springs and has the advantages of being easy to operate, high in robustness and suitable for solving various complex problems and having a few constraints. However, most optimization algorithm-based estimation methods have a low convergence rate and are easily trapped in local optimum. The salp swarm algorithm is a novel evolutionary optimization algorithm for numerical optimization. Existing salp swarm algorithms search for a globally optimal solution of an optimized target through a certain number of iterations using a random trial-and-error method after an objective function and parameters to be optimized are determined, so as to obtain optimal solutions of the parameters. However, existing salp swarm algorithms, when used for solving the design parameters of extension/compression springs, still have the problem of low design parameter solving accuracy.

### BRIEF SUMMARY OF THE INVENTION

The technical issue to be settled by the invention is to provide a method for solving parameters of extension/compression springs by an AC salp swarm algorithm, which have high design parameter solving accuracy.

The technical solution adopted by the invention to settle the above technical issue is as follows: a method for solving parameters of extension/compression springs by an AC salp swarm algorithm comprises the following steps:
S1: determining design parameters to be solved of an extension/compression spring:
S2: constructing an objective function for solving the design parameters of the extension/compression spring based on a design objective of the extension/compression spring, wherein the design objective of the extension/compression spring is to minimize a weight of the extension/compression spring;
S3: determining constraints of the design parameters of the extension/compression spring; and
S4: performing iterative optimization on the design parameters of the extension/compression spring using an AC salp swarm algorithm to obtain a globally optimal solution, and outputting the globally optimal solution as solved design parameters of the extension/compression spring, wherein the AC salp swarm algorithm is obtained by adding an AC operation between individuals during an iteration process of an existing salp swarm algorithm.

The design parameters to be solved of the extension/compression spring in S1 are respectively a wire diameter d, a mean coil diameter D and a number N of effective coils.

The objective function constructed in S2 is expressed by formula (1):

$$f ( d , D , N ) = {d}^{2} D ( N + 2 ) \qquad ( 1 )$$

In formula (1), a value of d satisfies 0.05≤d≤2, a value of D satisfies 0.25≤D≤1.3, and a value of N satisfies 2≤N≤15.

The constraints of the design parameters of the extension/compression spring determined in S3 are expressed by formula (2) to formula (5):

$$\begin{matrix}{C}_{1} = 1 - \frac{{D}^{3} N}{71785 {d}^{4}} \leq 0 & ( 2 ) \\ {C}_{2} = \frac{4 {D}^{2} - dD}{12566 {d}^{3} ( D - d )} + \frac{1}{5108 {d}^{2}} - 1 \leq 0 & ( 3 ) \\ {C}_{3} = 1 - \frac{140.45 d}{{D}^{2} N} \leq 0 & ( 4 ) \\ {C}_{4} = \frac{d + D}{1.5} - 1 \leq 0 & ( 5 )\end{matrix}$$

Where, C₁ represents a minimum deflection constraint of the extension/compression spring. C₂ represents a shear constraint of the extension/compression spring. C₃ represents an impact frequency constraint of the extension/compression spring, and C₄ represents an outer diameter constraint of the extension/compression spring.

The process of performing iterative optimization on the design parameters of the extension/compression spring using an AC salp swarm algorithm to obtain the globally optimal solution and outputting the globally optimal solution as solved design parameters of the extension/compression spring in S4 comprises:
S4.1: initializing parameters of the AC salp swarm algorithm: setting a population size popsize=50, setting a population dimension dim=3, setting an iteration variable t, setting a maximum iteration max_t=2000, setting a variable p, setting a variable count, setting a lower boundary lb=[lb₁, lb₂, lb₃]=[0.05. 0.25, 2], and setting an upper boundary ub=[ub₁, ub₂, ub₃]=[2, 1.3, 15], wherein lb₁ is a lower limit (minimum value) of d, lb₂ is a lower limit (minimum value) of D, lb₃ is a lower limit (minimum value) of N, ub₁ is an upper limit (maximum value) of d, ub₂ is an upper limit (maximum value) of D, and ub₃ is an upper limit (maximum value) of N; initializing t, p and count respectively, p=0, count=0, t=0;
S4.2: initializing a population by formula (6) to obtain a 0-generation population, which is marked as X⁰, wherein X⁰ is a matrix with popsize rows and dim columns, a first column of data of X⁰ represents the parameter d, a second column of data of X⁰ represents the parameter D, a third column of data of X⁰ represents the parameter N, each row of data serves as a solution of one of the design parameters of the extension/compression spring and is also referred to as an individual, and an i^{th} row of data is an i^{th} individual; correspondingly substituting the three columns of data of each individual in the 0-generation population X⁰ into formula (1) to obtain an objective function value of the corresponding individual, saving the objective function value of each individual in the 0-generation population X⁰ in XFitness, and marking the i^{th} objective function value in XFitness as XFitness, wherein XFitness; is correspondingly the objective function value of the i^{th} individual in the 0-generation population X⁰, and i=1, 2, . . . , popsize; determining a minimum objective function value in XFitness, which is marked as bestFitness, and taking the individual corresponding to the minimum objective function value as a minimum individual, which is marked as bestSolution, copying X⁰ to SaveX, and copying XFitness to SaveXFitness:

$${X}_{i , j}^{0} = {lb}_{j} + rand * ( {ub}_{j} - {lb}_{j} ) \qquad ( 6 )$$

wherein, in formula (6), j=1, 2, dim, X_{i,j}⁰ represents a value in a j^{th} column of a i^{th} individual in the 0-generation population X⁰, rand represents a random number following uniform distribution between 0 and 1, and before each calculation by formula (6), rand is generated by a random function;
S4.3: updating the value of t with a sum of the current value of t and 1, and then performing a t^{th} iteration on the population to obtain a t-generation population X^{t}, wherein the iteration process comprises:
S4.3.1: substituting the current value of t into formula (7) to obtain C₁, setting a traversal variable current, and initializing current, current=1;
S4.3.2: traversing the (current)^{th} individual in a (t−1)-generation population X^{t-1}, at this moment, randomly selecting two different integers, which are not equal to current, from 1 to popsize, randomly marking the two integers as a and b, and then determining whether current is less than or equal to popsize/2; if current is less than or equal to popsize/2, randomly generating a random number between 0 and 1, and then determining whether the random number is less than the current value of p; if the random number is less than the current value of p, obtaining the (current)^{th} individual in the t-generation population X^{t} by formula (8); otherwise, obtaining the value of the (current)^{th} individual in the t-generation population X^{t} by formula (9); if current is not less than or equal to popsize/2, obtaining the (current)^{th} individual in the t-generation population X^{t} by formula (10);

$$\begin{matrix}{c}_{1} = 2 {e}^{- {( \frac{4 t}{max \_ t} )}^{2}} & ( 7 ) \\ {X}_{current , j}^{t} = \{ \begin{matrix}{bestSolution}_{j} + {c}_{1} * ( ( {ub}_{j} - {lb}_{j} ) * {c}_{2} * {lb}_{j} ) & {c}_{3} < 0.5 \\ {bestSolution}_{j} - {c}_{1} * ( ( {ub}_{j} - {lb}_{j} ) * {c}_{2} * {lb}_{j} ) & {c}_{3} \geq 0.5\end{matrix} & ( 8 ) \\ {X}_{current , j}^{t} = {X}_{current , j}^{t - 1} * {X}_{a , j}^{t - 1} / {X}_{b , j}^{t - 1} & ( 9 ) \\ {X}_{current , j}^{t} = ( {X}_{current - 1 , j}^{t - 1} + {X}_{current , j}^{t - 1} ) / 2 & ( 10 )\end{matrix}$$

wherein, C₂ and C₃ are respectively random numbers between 0 and 1, and before each calculation by formula (8). C₂ and C₃ are randomly generated by the random function; X_{current,j}^{t} represents a value in a j^{th} column of the (current)^{th} individual in the t-generation population X^{t}, X_{current,j}^{t-1} represents a value in a j^{th} column of the (current)^{th} individual in the (t−1)-generation population X^{t-1}, and bestSolution; represents a value in a j^{th} column of the current minimum individual bestSolution; X_{a,j}^{t-1} represents a value in a j^{th} column of a a^{th} individual in the (t−1)-generation population X^{t-1}, X_{b,j}^{t-1} represents a value in a j^{th} column of a b^{th} individual in the (t−1)-generation population X^{t-1}, and X_{current-1,j}^{t}−1 represents a value in a j^{th} column of a (current−1)^{th} individual in the (t−1)-generation population X^{t-1};
S4.3.3: generating a random number between 0 and 1, and determining whether the random number is less than or equal to 1−t/max_t; if so, updating SaveX_{current,j} with X_{current,j}^{t}; otherwise, remaining SaveX_{current,j} unchanged, wherein SaveX_{current,j} represents a value in a j^{th} column of the (current)^{th} individual in SaveX;
S4.3.4: determining whether the value in each column of the (current)^{th} individual in the t-generation population X^{t} obtained in S4.3.1 is between a corresponding upper limit and a corresponding lower limit; if so, remaining the value unchanged; otherwise, determining an absolute value of a difference between a value in said column and the corresponding upper limit and an absolute value of a difference between the value in said column and the corresponding lower limit; if the absolute value of the difference between the value in said column and the corresponding upper limit is greater than the absolute value of the difference between the value in said column and the corresponding lower limit, modifying the value in said column into the corresponding lower limit; otherwise, modifying the value in said column into the corresponding upper limit;
S4.3.5: corresponding substituting the three columns of data of the (current)^{th} individual in the t-generation population X^{t} obtained in S4.3.4 into four constraints in formula (2), formula (3), formula (4) and formula (5); if the four constraints are all satisfied, corresponding substituting the three columns of data of the (current)^{th} individual in the t-generation population X^{t} into formula (1) to calculate an objective function value, and updating XFitness_{current} with the objective function value; if the four constraints are not all satisfied, updating XFitness_{current} with the current value of bestFitness:
S4.3.6: determining XFitness_{current} as follows, and performing a corresponding operation based on a determination result:

if the current value of XFitness_{current} is less than the current value of SaveXFitness_{current}, updating SaveXFitness_{current} with the current value of XFitness_{current}, and updating SaveX_{current} with the current value of X_{current}^{t}; otherwise, updating X_{current}^{t} with the current value of SaveX_{current}:

if the current value of XFitness_{current} is less than the current value of bestFitness, updating bestSolution with the current value of X_{current}^{t}, updating bestFitness with the current value of XFitness_{current}, and updating count with a quotient obtained by dividing the current value of count by 2; otherwise, updating count with the sum of the current value of count and 1; and

S4.3.7: determining whether the current value of current is less than popsize: if so, updating current with the sum of the current value of current and 1, and returning to S4.3.2 to traverse the next individual; otherwise, performing S4.4; and

S4.4: if the current value of count is greater than or equal to 10*popsize, setting p to 0.8; otherwise, setting p to 0; determining whether the current value of t is equal to max_t; if not, returning to S4.3 to perform the next iteration; if so, taking the current value of bestFitness as the globally optimal solution, which is the solved design parameters the extension/compression spring.

Compared with the prior art, the invention has the following advantages: an existing salp swarm algorithm is improved, and an AC salp swarm algorithm obtained by adding an AC operation between individuals during the iteration process of the existing salp swarm algorithm is used for iterative optimization of design parameters of an extension/compression spring to obtain a globally optimal solution, which is output as solved design parameters of the extension/compression springs; because three parameters (mean coil diameter D, wire diameter d and number N of effective coils) are involved in design of the extension/compression spring and each parameter has its own range, the real solution space of the three parameters is extremely large. By adding the AC operation, a desirable solution can be obtained by combining existing solutions to gradually find a desired parameter solution for the design of the extension/compression spring. Compared with the existing salp swarm algorithm which completely relies on the random trial—and—error method, the AC operation adopted by the AC salp swarm algorithm is more promising in finding a better solution, thus guaranteeing the high accuracy of finally solved design parameters.

### BRIEF DESCRIPTION OF THE SEVERAL VIEWS OF THE DRAWINGS

FIG. 1 is a schematic diagram of three parameters marked out in an extension/compression spring involved in a method for solving parameters of extension/compression springs by an AC salp swarm algorithm according to the invention.

### DETAILED DESCRIPTION OF THE INVENTION

The invention is described in further detailed below in conjunction with the accompanying drawing and embodiment.

Embodiment: a method for solving parameters of extension/compression springs by an AC salp swarm algorithm comprises the following steps:
S1: determining design parameters to be solved of an extension/compression spring:
S2: constructing an objective function for solving the design parameters of the extension/compression spring based on a design objective of the extension/compression spring, wherein the design objective of the extension/compression spring is to minimize the weight of the extension/compression spring;
S3: determining constraints of the design parameters of the extension/compression spring; and
S4: performing iterative optimization on the design parameters of the extension/compression spring using an AC salp swarm algorithm to obtain a globally optimal solution, and outputting the globally optimal solution as solved design parameters of the extension/compression spring, wherein the AC salp swarm algorithm is obtained by adding an AC operation between individuals during an iteration process of an existing salp swarm algorithm.

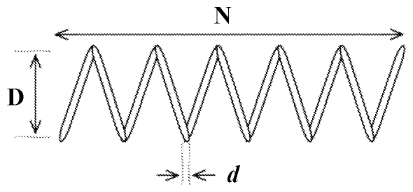

In this embodiment, as shown in FIG. 1, the design parameters to be solved of the extension/compression spring in S1 are respectively the wire diameter d, the mean coil diameter D and the number N of effective coils.

In this embodiment, the objective function constructed in S2 is expressed by formula (1):

$$f ( d , D , N ) = {d}^{2} D ( N + 2 ) \qquad ( 1 )$$

In formula (1), the value of d satisfies 0.05≤d≤2, the value of D satisfies 0.25≤D≤1.3, and the value of N satisfies 2≤N≤15.

In this embodiment, the constraints of the design parameters of the extension/compression spring determined in S3 are expressed by formula (2) to formula (5):

$$\begin{matrix}{C}_{1} = 1 - \frac{{D}^{3} N}{71785 {d}^{4}} \leq 0 & ( 2 ) \\ {C}_{2} = \frac{4 {D}^{2} - dD}{12566 {d}^{3} ( D - d )} + \frac{1}{5108 {d}^{2}} - 1 \leq 0 & ( 3 ) \\ {C}_{3} = 1 - \frac{140.45 d}{{D}^{2} N} \leq 0 & ( 4 ) \\ {C}_{4} = \frac{d + D}{1.5} - 1 \leq 0 & ( 5 )\end{matrix}$$

Where, C₁ represents a minimum deflection constraint of the extension/compression spring. C₂ represents a shear constraint of the extension/compression spring. C₃ represents an impact frequency constraint of the extension/compression spring, and C₄ represents an outer diameter constraint of the extension/compression spring.

In this embodiment, the process of performing iterative optimization on the design parameters of the extension/compression spring using an AC salp swarm algorithm to obtain a globally optimal solution and outputting the globally optimal solution as solved design parameters of the extension/compression spring in S4 comprises:
S4.1: initializing parameters of the AC salp swarm algorithm: setting a population size popsize=50, setting a population dimension dim=3, setting an iteration variable t, setting a maximum iteration max_t−2000, setting a variable p, setting a variable count, setting a lower boundary lb=[lb₁, lb₂, lb₃]=[0.05. 0.25, 2], and setting an upper boundary ub=[ub₁, ub₂, ub₃]=[2. 1.3, 15], wherein lb₁ is a lower limit (minimum value) of d, lb₂ is a lower limit (minimum value) of D, lb₃ is a lower limit (minimum value) of N, ub₁ is an upper limit (maximum value) of d, ub₂ is an upper limit (maximum value) of D, and ub₃ is an upper limit (maximum value) of N; initializing t, p and count respectively, p=0, count=0, t=0;
S4.2: initializing a population by formula (6) to obtain a 0-generation population, which is marked as X⁰, wherein X⁰ is a matrix with popsize rows and dim columns, the first column of data of X⁰ represents the parameter d, the second column of data of X⁰ represents the parameter D, the third column of data of X⁰ represents the parameter N, each row of data serves as a solution of one of the design parameters of the extension/compression spring and is also referred to as an individual, and the i^{th} row of data is the i^{th} individual; correspondingly substituting the three columns of data of each individual in the 0-generation population X⁰ into formula (1) to obtain an objective function value of the corresponding individual, saving the objective function value of each individual in the 0-generation population X⁰ in XFitness, and marking the i^{th} objective function value in XFitness as XFitness, wherein XFitness; is correspondingly the objective function value of the i^{th} individual in the 0-generation population X⁰, and i=1, 2 . . . , popsize; determining a minimum objective function value in XFitness, which is marked as bestFitness, and taking the individual corresponding to the minimum objective function value as a minimum individual, which is marked as bestSolution, copying X⁰ to SaveX, and copying XFitness to SaveXFitness:

$${X}_{i , j}^{0} = {lb}_{j} + rand * ( {ub}_{j} - {lb}_{j} ) \qquad ( 6 )$$

wherein, in formula (6), j=1, 2, dim, X_{i,j}⁰, represents the value in the j^{th} column of the i^{th} individual in the 0-generation population X⁰, rand represents a random number following uniform distribution between 0 and 1, and before each calculation by formula (6), rand is generated by a random function;
S4.3: updating the value of t with the sum of the current value of t and 1, and then performing a t^{th} iteration on the population to obtain a t-generation population X^{t}, wherein the iteration process comprises:
S4.3.1: substituting the current value of t into formula (7) to obtain C₁, setting a traversal variable current, and initializing current, current=1;
S4.3.2: traversing the (current)^{th} individual in a (t−1)-generation population X^{t-1}, at this moment, randomly selecting two different integers, which are not equal to current, from 1 to popsize, randomly marking the two integers as a and b, and then determining whether current is less than or equal to popsize/2; if current is less than or equal to popsize/2, randomly generating a random number between 0 and 1, and then determining whether the random number is less than the current value of p; if the random number is less than the current value of p, obtaining the (current)^{th} individual in the t-generation population X^{t} by formula (8); otherwise, obtaining the value of the (current)^{th} individual in the t-generation population X^{t} by formula (9); if current is not less than or equal to popsize/2, obtaining the (current)^{th} individual in the t-generation population X^{t} by formula (10);

$$\begin{matrix}{c}_{1} = 2 {e}^{- {( \frac{4 t}{max \_ t} )}^{2}} & ( 7 ) \\ {X}_{current , j}^{t} = \{ \begin{matrix}{bestSolution}_{j} + {c}_{1} * ( ( {ub}_{j} - {lb}_{j} ) * {c}_{2} * {lb}_{j} ) & {c}_{3} < 0.5 \\ {bestSolution}_{j} - {c}_{1} * ( ( {ub}_{j} - {lb}_{j} ) * {c}_{2} * {lb}_{j} ) & {c}_{3} \geq 0.5\end{matrix} & ( 8 ) \\ {X}_{current , j}^{t} = {X}_{current , j}^{t - 1} * {X}_{a , j}^{t - 1} / {X}_{b , j}^{t - 1} & ( 9 ) \\ {X}_{current , j}^{t} = ( {X}_{current - 1 , j}^{t - 1} + {X}_{current , j}^{t - 1} ) / 2 & ( 10 )\end{matrix}$$

wherein, C₂ and C₃ are respectively random numbers between 0 and 1, and before each calculation by formula (8), C₂ and C₃ are randomly generated by a random function; X_{current,j} represents the value in the j^{th} column of the (current)^{th} individual in the t-generation population X^{t}. X^{t}−1 current,j represents the value in the j^{th} column of the (current)^{th} individual in the (t−1)-generation population X^{t-1}, and bestSolution; represents the value in the j^{th} column of the current minimum individual bestSolution; X_{a,j}^{t-1} represents the value in the j^{th} column of the a^{th} individual in the (t−1)-generation population X^{t-1}, X_{b,j}^{t-1} represents the value in the j^{th} column of the b^{th} individual in the (t−1)-generation population X^{t-1}, and X_{current-1,j}^{t-1} represents the value in the j^{th} column of the (current−1)^{th} individual in the (t−1)-generation population X^{t-1};
S4.3.3: generating a random number between 0 and 1, and determining whether the random number is less than or equal to 1−t/max_t; if so, updating SaveX_{current,j} with X_{current,j}; otherwise, remaining SaveX_{current,j} unchanged, wherein SaveX_{current}, represents the value in the j^{th} column of the (current)^{th} individual in SaveX;
S4.3.4: determining whether the value in each column of the (current)^{th} individual in the t-generation population X^{t} obtained in S4.3.1 is between the corresponding upper limit and a corresponding lower limit; if so, remaining the value unchanged; otherwise, determining an absolute value of a difference between the value in said column and the corresponding upper limit and an absolute value of a difference between the value in said column and the corresponding lower limit; if the absolute value of the difference between the value in said column and the corresponding upper limit is greater than the absolute value of the difference between the value in said column and the corresponding lower limit, modifying the value in said column into the corresponding lower limit; otherwise, modifying the value in said column into the corresponding upper limit;
S4.3.5: corresponding substituting the three columns of data of the (current)^{th} individual in the t-generation population X^{t} obtained in S4.3.4 into the four constraints in formula (2), formula (3), formula (4) and formula (5); if the four constraints are all satisfied, corresponding substituting the three columns of data of the (current)^{th} individual in the t-generation population X^{t} into formula (1) to calculate an objective function value, and updating XFitness_{current} with the objective function value; if the four constraints are not all satisfied, updating XFitness_{current} with the current value of bestFitness;
S4.3.6: determining XFitness_{current} as follows, and performing a corresponding operation based on a determination result:

if the current value of XFitness_{current} is less than the current value of SaveXFitness_{current}, updating SaveXFitness_{current} with the current value of XFitness_{current}, and updating SaveX_{current} with the current value of X_{current}^{t}; otherwise, updating X_{current}^{t} with the current value of SaveX_{current};

if the current value of XFitness_{current} is less than the current value of bestFitness, updating bestSolution with the current value of X_{current}, updating bestFitness with the current value of XFitness_{current}, and updating count with a quotient obtained by dividing the current value of count by 2; otherwise, updating count with the sum of the current value of count and 1; and
S4.3.7: determining whether the current value of current is less than popsize: if so, updating current with the sum of the current value of current and 1, and returning to S4.3.2 to traverse the next individual; otherwise, performing S4.4; and
S4.4: if the current value of count is greater than or equal to 10*popsize, setting p to 0.8; otherwise, setting p to 0; determining whether the current value of t is equal to max_t; if not, returning to S4.3 to perform the next iteration; if so, taking the current value of bestFitness as the globally optimal solution, which is the solved design parameters the extension/compression spring.

A Window10 operating system, an 8 GB RAM, an Intel (R) Core (TM) i7-9700 CPU and MATLAB R2018b software are used for implementing the method for solving parameters of extension/compression springs by an AC salp swarm algorithm. Then, the design parameters of the extension/compression spring are solved respectively by the method for solving parameters of extension/compression springs by an AC salp swarm algorithm and an existing salp swarm algorithm, and solved data are shown in Table 1:

TABLE 1

| | | | | objective |
|---|---|---|---|---|
| | | | | function |
| Method | d | D | N | value |
| The invention | 0.051766599 | 0.358585825 | 11.18028561 | 0.01266535 |
| Existing salp | 0.051207 | 0.345215 | 12.004032 | 0.0126763 |
| swarm | | | | |
| algorithm | | | | |

In Table 1, three parameters (mean coil diameter D, wire diameter d and the number N of effective coils) involved in the design of the extension/compression spring and the weight of the extension/compression spring are shown in the first row, a solution and target objective function value obtained by the method provided by the invention are shown in the second row, and a solution and target objective function value obtained the existing salp swarm algorithm are shown in the third row. It can be known, by analyzing Table 1, that these two methods both can satisfy the value range of d, the value range of D, the value range of N and the four constraints involved in the design of the extension/compression spring. The objective function value 0.01266535 obtained by the method of the invention is less than the objective function value 0.0126763 obtained by the exiting salp swarm algorithm, indicating that the accuracy of the parameters of the extension/compression spring solved by the invention is higher than that of the parameters solved by the exiting salp swarm algorithm.

1. A method for solving parameters of extension/compression spring by an AC salp swarm algorithm, comprises the following steps:
S1: determining design parameters to be solved of an extension/compression spring;
S2: constructing an objective function for solving the design parameters of the extension/compression spring based on a design objective of the extension/compression spring, wherein the design objective of the extension/compression spring is to minimize a weight of the extension/compression spring;
S3: determining constraints of the design parameters of the extension/compression spring; and
S4: performing iterative optimization on the design parameters of the extension/compression spring using an AC salp swarm algorithm to obtain a globally optimal solution, and outputting the globally optimal solution as solved design parameters of the extension/compression spring, wherein the AC salp swarm algorithm is obtained by adding an AC operation between individuals during an iteration process of an existing salp swarm algorithm.

2. The method for solving parameters of extension/compression springs by the AC salp swarm algorithm according to claim 1, wherein the design parameters to be solved of the extension/compression spring in S1 are respectively a wire diameter d, a mean coil diameter D and a number N of effective coils.

3. The method for solving parameters of extension/compression springs by the AC salp swarm algorithm according to claim 2, wherein the objective function constructed in S2 is expressed by formula (1):
$$f ( d , D , N ) = {d}^{2} D ( N + 2 ) \qquad ( 1 )$$
wherein in formula (1), a value of d satisfies 0.05≤d≤2, a value of D satisfies 0.25≤D≤1.3, and a value of N satisfies 2≤N≤15.

4. The method for solving parameters of extension/compression springs by the AC salp swarm algorithm according to claim 3, wherein the constraints of the design parameters of the extension/compression spring determined in S3 are expressed by formula (2) to formula (5):
$$\begin{matrix}{C}_{1} = 1 - \frac{{D}^{3} N}{71785 {d}^{4}} \leq 0 & ( 2 ) \\ {C}_{2} = \frac{4 {D}^{2} - dD}{12566 {d}^{3} ( D - d )} + \frac{1}{5108 {d}^{2}} - 1 \leq 0 & ( 3 ) \\ {C}_{3} = 1 - \frac{140.45 d}{{D}^{2} N} \leq 0 & ( 4 ) \\ {C}_{4} = \frac{d + D}{1.5} - 1 \leq 0 & ( 5 )\end{matrix}$$
Where, C₁ represents a minimum deflection constraint of the extension/compression spring, C₂ represents a shear constraint of the extension/compression spring, C₃ represents an impact frequency constraint of the extension/compression spring, and C₄ represents an outer diameter constraint of the extension/compression spring.

5. The method for solving parameters of extension/compression springs by the AC salp swarm algorithm according to claim 4, wherein a process of performing iterative optimization on the design parameters of the extension/compression spring using an AC salp swarm algorithm to obtain the globally optimal solution and outputting the globally optimal solution as solved design parameters of the extension/compression spring in $4 comprises:
S4.1: initializing parameters of the AC salp swarm algorithm: setting a population size popsize=50, setting a population dimension dim=3, setting an iteration variable t, setting a maximum iteration max_t=2000, setting a variable p, setting a variable count, setting a lower boundary lb=[/b1, lb₂, lb₃]=[0.05, 0.25, 2], and setting an upper boundary ub=[ub₁, ub₂, ub₃]=[2, 1.3, 15], wherein lb₁ is a lower limit (minimum value) of d, lb₂ is a lower limit (minimum value) of D, lb₃ is a lower limit (minimum value) of N, ub₁ is an upper limit (maximum value) of d, ub₂ is an upper limit (maximum value) of D, and ub₃ is an upper limit (maximum value) of N; initializing t, p and count respectively, p=0, count=0, t=0;
S4.2: initializing a population by formula (6) to obtain a 0-generation population, which is marked as X⁰, wherein X⁰ is a matrix with popsize rows and dim columns, a first column of data of X⁰ represents the parameter d, a second column of data of X⁰ represents the parameter D, a third column of data of X⁰ represents the parameter N, each row of data serves as a solution of one of the design parameters of the extension/compression spring and is also referred to as an individual, and an i^{th} row of data is an i^{th} individual; correspondingly substituting the three columns of data of each individual in the 0-generation population X⁰ into formula (1) to obtain an objective function value of the corresponding individual, saving the objective function value of each individual in the 0-generation population X⁰ in XFitness, and marking the i^{th} objective function value in XFitness as XFitness, wherein XFitness; is correspondingly the objective function value of the i^{th} individual in the 0-generation population X⁰, and i=1, 2, . . . , popsize; determining a minimum objective function value in XFitness, which is marked as bestFitness, and taking the individual corresponding to the minimum objective function value as a minimum individual, which is marked as bestSolution, copying X⁰ to SaveX, and copying XFitness to SaveXFitness:
$${X}_{i , j}^{0} = {lb}_{j} + rand * ( {ub}_{j} - {lb}_{j} ) \qquad ( 6 )$$
wherein, in formula (6), j=1, 2, dim, XL represents a value in a j^{th} column of a i^{th} individual in the 0-generation population X⁰, rand represents a random number following uniform distribution between 0 and 1, and before each calculation by formula (6), rand is generated by a random function;
S4.3: updating the value of t with a sum of the current value of t and 1, and then performing a t^{th} iteration on the population to obtain a t-generation population X^{t}, wherein the iteration process comprises:
S4.3.1: substituting the current value of t into formula (7) to obtain c₁, setting a traversal variable current, and initializing current, current=1;
S4.3.2: traversing the (current)^{th} individual in a (t−1)-generation population X^{t-1}, at this moment, randomly selecting two different integers, which are not equal to current, from 1 to popsize, randomly marking the two integers as a and b, and then determining whether current is less than or equal to popsize/2; if current is less than or equal to popsize/2, randomly generating a random number between 0 and 1, and then determining whether the random number is less than the current value of p; if the random number is less than the current value of p, obtaining the (current)^{th} individual in the t-generation population X′ by formula (8); otherwise, obtaining the value of the (current)^{th} individual in the t-generation population X^{t} by formula (9); if current is not less than or equal to popsize/2, obtaining the (current)^{th} individual in the t-generation population X^{t} by formula (10);
$$\begin{matrix}{c}_{1} = 2 {e}^{- {( \frac{4 t}{max \_ t} )}^{2}} & ( 7 ) \\ {X}_{current , j}^{t} = \{ \begin{matrix}{bestSolution}_{j} + {c}_{1} * ( ( {ub}_{j} - {lb}_{j} ) * {c}_{2} * {lb}_{j} ) & {c}_{3} < 0.5 \\ {bestSolution}_{j} - {c}_{1} * ( ( {ub}_{j} - {lb}_{j} ) * {c}_{2} * {lb}_{j} ) & {c}_{3} \geq 0.5\end{matrix} & ( 8 ) \\ {X}_{current , j}^{t} = {X}_{current , j}^{t - 1} * {X}_{a , j}^{t - 1} / {X}_{b , j}^{t - 1} & ( 9 ) \\ {X}_{current , j}^{t} = ( {X}_{current - 1 , j}^{t - 1} + {X}_{current , j}^{t - 1} ) / 2 & ( 10 )\end{matrix}$$
wherein, C₂ and c₃ are respectively random numbers between 0 and 1, and before each calculation by formula (8), C₂ and c₃ are randomly generated by the random function; X^{t} current,j represents a value in a j^{th} column of the (current)^{th} individual in the t-generation population X^{t}, X^{t}−1 current,j represents a value in a j^{th} column of the (current) th individual in the (t−1)-generation population X^{t-1}, and bestSolution; represents a value in a j^{th} column of the current minimum individual bestSolution; X^{t-1} represents a value in a j^{th} column of a a^{th} individual in the (t−1)-generation population X^{t-1}, X_{b,j}^{t-1} represents a value in a j^{th} column of a b^{th} individual in the (t−1)-generation population X^{t-1}, and X^{t}−1 X_{current-1,j}^{t-1} represents a value in a j^{th} column of a (current−1)^{th} individual in the (t−1)-generation population X^{t-1};
S4.3.3: generating a random number between 0 and 1, and determining whether the random number is less than or equal to 1−t/max_t; if so, updating SaveX_{current,j} with X_{current,j}^{t}; otherwise, remaining SaveX_{current,j} unchanged, wherein SaveX_{current},j represents a value in a j^{th} column of the (current)^{th} individual in SaveX;
S4.3.4: determining whether a value in each column of the (current)^{th} individual in the t-generation population X^{t} obtained in S4.3.1 is between a corresponding upper limit and a corresponding lower limit; if so, remaining the value unchanged; otherwise, determining an absolute value of a difference between a value in said column and the corresponding upper limit and an absolute value of a difference between the value in said column and the corresponding lower limit; if the absolute value of the difference between the value in said column and the corresponding upper limit is greater than the absolute value of the difference between the value in said column and the corresponding lower limit, modifying the value in said column into the corresponding lower limit; otherwise, modifying the value in said column into the corresponding upper limit;
S4.3.5: corresponding substituting the three columns of data of the (current) th individual in the t-generation population X^{t} obtained in S4.3.4 into four constraints in formula (2), formula (3), formula (4) and formula (5); if the four constraints are all satisfied, corresponding substituting the three columns of data of the (current)^{th} individual in the t-generation population X^{t} into formula (1) to calculate an objective function value, and updating XFitness_{current} with the objective function value; if the four constraints are not all satisfied, updating XFitness_{current} with the current value of bestFitness;
S4.3.6: determining XFitness_{current} as follows, and performing a corresponding operation based on a determination result:
if the current value of XFitness_{current} is less than the current value of SaveXFitness_{current}, updating SaveXFitness_{current} with the current value of XFitness_{current}, and updating SaveX_{current} with the current value of X_{current}^{t}; otherwise, updating X_{current}^{t} with the current value of SaveX_{current};
if the current value of XFitness_{current} is less than the current value of bestFitness, updating bestSolution with the current value of X_{current}^{t}, updating bestFitness with the current value of XFitness_{current}, and updating count with a quotient obtained by dividing the current value of count by 2; otherwise, updating count with the sum of the current value of count and 1; and
S4.3.7: determining whether the current value of current is less than popsize; if so, updating current with the sum of the current value of current and 1, and returning to S4.3.2 to traverse the next individual; otherwise, performing S4.4; and
S4.4: if the current value of count is greater than or equal to 10*popsize, setting p to 0.8; otherwise, setting p to 0; determining whether the current value of t is equal to max_t; if not, returning to S4.3 to perform the next iteration; if so, taking the current value of bestFitness as the globally optimal solution, which is the solved design parameters the extension/compression spring.
